(19) United States
(12) Patent Application Publication
(10) Pub. No.: US 2003/0026591 A1
(43) Pub. Date: Feb. 6, 2003

(54) Method for editing program in digital broadcasting receiver

(75) Inventor: Eun Sam Kim, Seoul (KR)

Correspondence Address: Jonathan Y. Kang, Esq., Lee & Hong P.C., 11th Floor, 221 N. Figueroa Street, Los Angeles, CA, 90012-2601, US

(73) Assignee: LG Electronics Inc.

(21) Appl. No.: 09/922,818

(22) Filed: Aug. 6, 2001

(51) Int. Cl. H04N 5/92; H04N 5/781

(52) U.S. Cl. 386/52; 386/125

(57) ABSTRACT

The present invention discloses a method for editing a program in a digital broadcasting receiver, which can support an editing function of recorded data of a digital broadcasting program, without using an additional hardware. Firstly, wanted programs are clipped from a plurality of recorded programs, the clipped programs are individually recorded, wanted programs are selected from the clipped and recorded programs, and the selected programs are merged in a predetermined order according to a merging operation, thus allowing a user to produce a new program.

### BACKGROUND OF THE INVENTION

1. Field of the Invention

The present invention relates to a digital TV, and in particular to a method for editing recorded data of a digital broadcasting program.

2. Description of the Related Art

A personal video recorder (PVR), which has been recently introduced by TiVo, Inc. and ReplayTV, Inc. in the USA, is designed to selectively record programs received from a plurality of broadcasting stations in a recording medium, such as a hard disk, connected with a TV STB, so that users can watch the recorded programs whenever they want to watch them.

According to the research result of Josh Bernoff who is a media analyzer publishing a PVR-related report, ‘the PVR will come into wide use in at least 80% of homes in a decade’. Thus, there are increasing demands for a time shift function in a digital broadcasting field.

As a time shift technology, U.S. Pat. No. 5,371,551 to Logan et al for ‘time delayed digital video system using concurrent recording and playback’ (Dec. 6, 1994) teaches ‘concurrent video recording and playback’.

In addition, TiVo, Inc. which is one of the front runners in the time shift technology has disclosed U.S. Pat. No. 6,215,526B1 to Barton et al for ‘analog video tagging and encoding system’ (Apr. 10, 2001) and U.S. Pat. No. 6,233,389B1 to Barton et al for ‘multimedia time warping system’ (May 15, 2001).

According to U.S. Pat. No. 6,215,526B1, when an analog TV signal is converted into an MPEG format digital TV signal, a tag field or tag frame is inserted to an analog video stream, thus obtaining a frame accurate capture in reception. It successfully prevents users from recording unnecessary segments, when a wanted live broadcasting program is broadcast late due to delay of a previous program. Therefore, when the program is actually broadcast, it starts to be recorded.

On the other hand, U.S. Pat. No. 6,233,389B1 cites U.S. Pat. No. 5,371,551 of Logan et al as its prior art, and suggests the followings: it would be advantageous to provide a multimedia time warping system that utilizes an approach that decouples the microprocessor from the high video data rates, thereby reducing the microprocessor and system requirements which are at a premium and giving the user the ability to simultaneous record and playback TV broadcasting programs. That is, in order to release the microcomputer from the high video rates, an MPEG stream is extracted from a received TV signal, and an A/V component is separated from the stream.

However, the conventional methods relate merely to a time shift function for personal video recording and a recording method of a data stream, but do not teach a method for editing a recorded program, extracting wanted segments from the program, and reproducing the extracted segments.

A hard disk video recorder (SVR-715) of Sony Corporation in Japan is directed to a method for editing a recorded program.

Referring to FIG. 2, a user selects a predetermined point of a program recorded in a recording medium such as a hard disk, and individually stores a period between a start point or end point of the program and the selected point for edition.

However, the start or end point of the program is always designated as the start or end point of the period. Accordingly, when the user intends to record and edit a period, which does not include the start or end point of the program, the user should perform more operations.

Moreover, in order to reproduce program segments of the corresponding period in a certain order, the user should designate the period in a wanted playback order in the recording operation.

As a result, the conventional method for editing the program in the digital broadcasting receiver has the following disadvantages:

Firstly, the program editing function of the MPEG-2 streams does not include a function allowing a user to edit the currently recorded MPEG-2 streams in a wanted type because a server should re-encode the streams to be edited with a high-priced device.

Secondly, the DTV-STB are not economically advantageous in respect of hardware, and require additional hardware functions such as a clock for generating a time stamp.

### SUMMARY OF THE INVENTION

It is, therefore, an object of the present invention to provide a method for editing a program in a digital broadcasting receiver, which can support a program editing function of MPEG-2 streams, without using an additional hardware such as an MPEG-2 encoder.

To achieve the above object, there is provided a method for editing a program in a digital broadcasting receiver wherein wanted segments are clipped from a plurality of recorded programs, the clipped segments are recorded, wanted programs are selected from the clipped and recorded programs, and the selected programs are merged in a predetermined order according to a merging operation, whereby a user can produce a new program.

### BRIEF DESCRIPTION OF THE DRAWINGS

The above objects, features and advantages of the present invention will become more apparent from the following detailed description when taken in conjunction with the accompanying drawings, in which:

FIG. 1 is a structure diagram illustrating a PVR system for providing an editing function of MPEG-2 streams;

FIG. 2 is a concept diagram illustrating a conventional splitting and merging method of a digital broadcasting receiver;

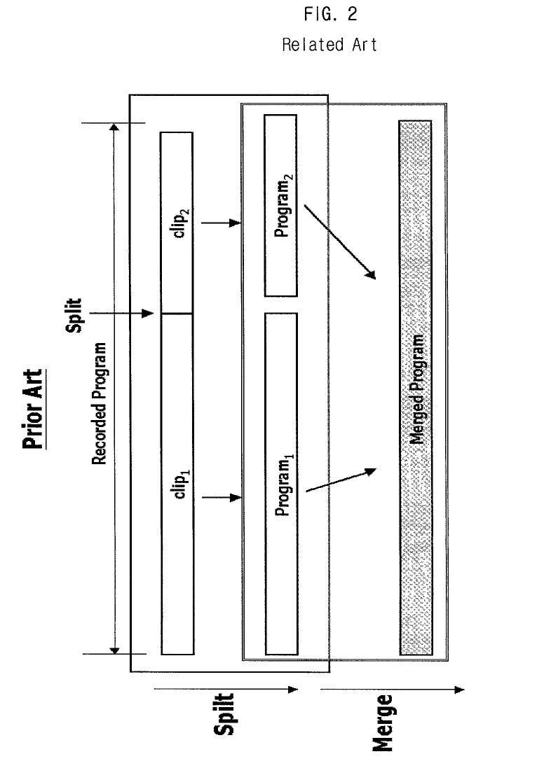

FIG. 3 is a concept diagram illustrating a clipping and merging method of a digital broadcasting receiver in accordance with the present invention;

FIG. 4 is a flowchart showing a clipping method of the digital broadcasting receiver in accordance with the present invention; and

FIG. 5 is a flowchart showing a merging method of the digital broadcasting receiver in accordance with the present invention.

### DETAILED DESCRIPTION OF THE PREFERRED EMBODIMENT

A preferred embodiment of the present invention will now be described with reference to the accompanying drawings. In the following description, same drawing reference numerals are used for the same elements even in different drawings. The matters defined in the description such as a detailed construction and elements of a circuit are nothing but the ones provided to assist in a comprehensive understanding of the invention. Thus, it is apparent that the present invention can be carried out without those defined matters. Also, well-known functions or constructions are not described in detail since they would obscure the invention in unnecessary detail.

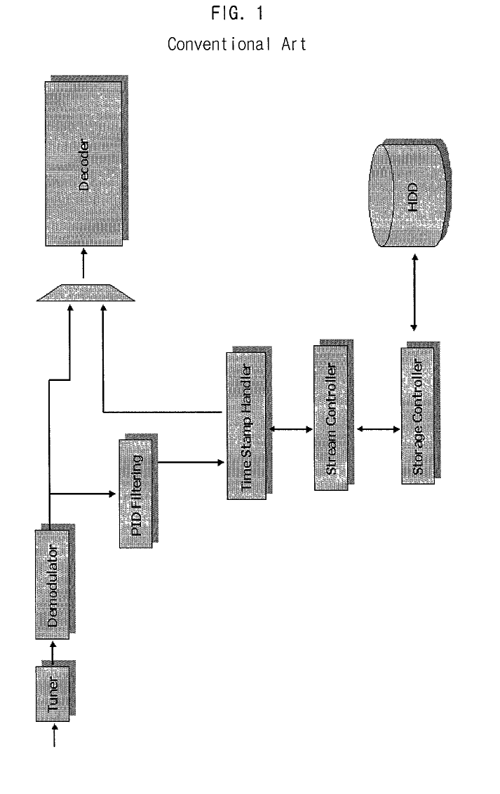

FIG. 1 is a structure diagram illustrating a PVR system for providing an editing function of MPEG-2 streams.

As illustrated in FIG. 1, the PVR system includes: a tuner 10 for tuning a received broadcasting signal; a demodulator 20 for demodulating the output signal from the tuner 10, and outputting a live stream; a data PID filter 30 for filtering the live stream from the demodulator 20, and detecting a TS stream to be stored; a time stamp handler 40 for inserting a time stamp into the TS signal; a storing unit 80 for storing the TS signal from the time stamp handler 40; a stream controller 50 for controlling clipping and merging of the stream stored in the storing unit 80; a storage controller 60 for managing the stream stored in the storing unit 80; a mux 70 for selecting one of the output signals from the stamp controller 50 and the demodulator 20, and outputting the selected signal; and a decoder 90 for decoding the output signal from the mux 70.

FIG. 1 shows the PVR system for providing the general editing function of the MPEG-2 stream, which is not essential to provide the editing function of the present invention. It will become more apparent from the following detailed description of the method for editing the program in the digital broadcasting receiver with a clipping and merging function in accordance with the present invention.

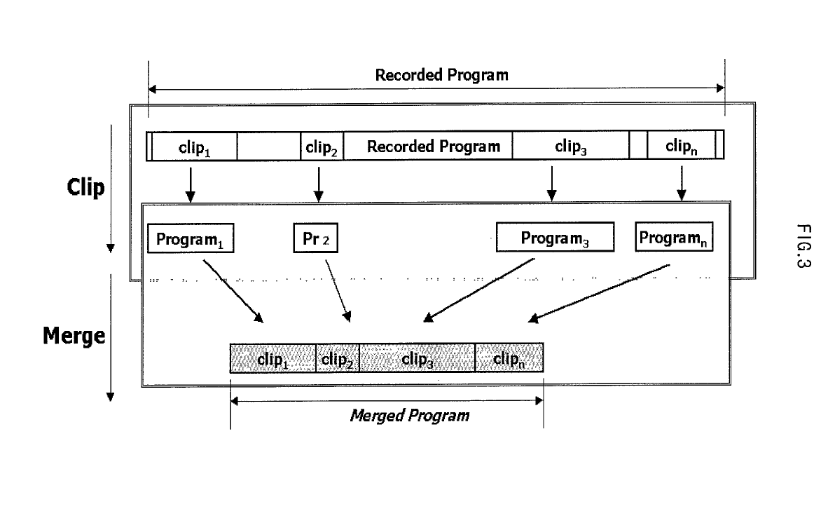

A clipping and merging method of the digital broadcasting receiver in accordance with the present invention will now be explained with reference to FIG. 3.

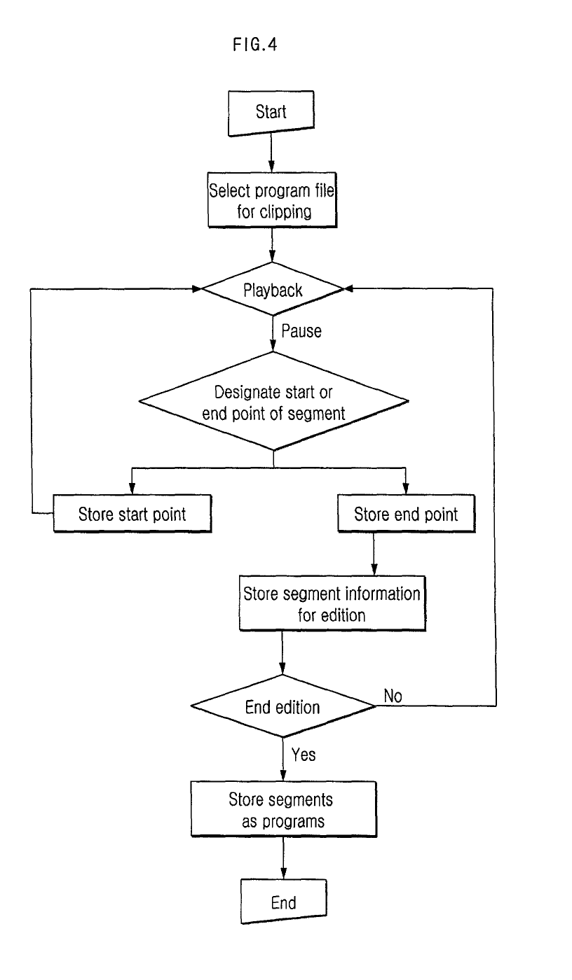

In a clipping process, program segments Clip1, Clip2, . . . , Clipn are clipped from a program recorded in a recording medium such as a hard disk upon the user's request. Then, the clipped program segments are respectively recorded as programs Program1, Program 2, . . . Programn. The clipping process will later be described in more detail with reference to FIG. 4.

In a merging process, the programs Program1, Program 2, . . . , Programn are merged in a predetermined number and order upon the user's selection, so that the user can produce a program including merely wanted segments from the previously-recorded program.

The recorded program may be provided in a multiple number. For example, segments are clipped from programs recorded in various channels, stored, and merged in a predetermined number and order, thus allowing the user to produce a new program.

In addition, segments can be simultaneously clipped from a recorded program from CH1, recorded program from CH2, . . . , and recorded program from CHn.

FIG. 4 is a flowchart showing the clipping method of the digital broadcasting receiver in accordance with the present invention.

Firstly, a program is selected for clipping by the user (S10). Here, the user may select a plurality of programs from different channels, and add a general search function to select the programs.

The program selected in S10 is reproduced on a screen (S20). Exemplary playback methods include a full stream playback, a skip over playback reproducing a predetermined amount of program at a predetermined time interval, and a slide playback of Thumnail.

While the program is being reproduced in S20, the user designates a period to be recorded. The designated start and end points are stored as start and end points of the period in the system (S40A, S40B).

When the user finishes the clipping process of the program, designates the start and end point (S30), and stores them in the system (S40A, S40B), information of the program segments Clip1, Clip2, . . . , Clipn of FIG. 3 is stored (S50), thereby finishing edition of the program segment Clip1 according to a clipping operation of the recorded program (S60). In order to perform an additional clipping operation, the routine returns to S20 and goes through S20 to S60. For example, when the clipping operation is performed a few times (n times), the segments Clip1, Clip2, . . . , Clipn are individually recorded as programs Program1, Program2, . . . , Programn by employing the segment information stored in S50 (S70).

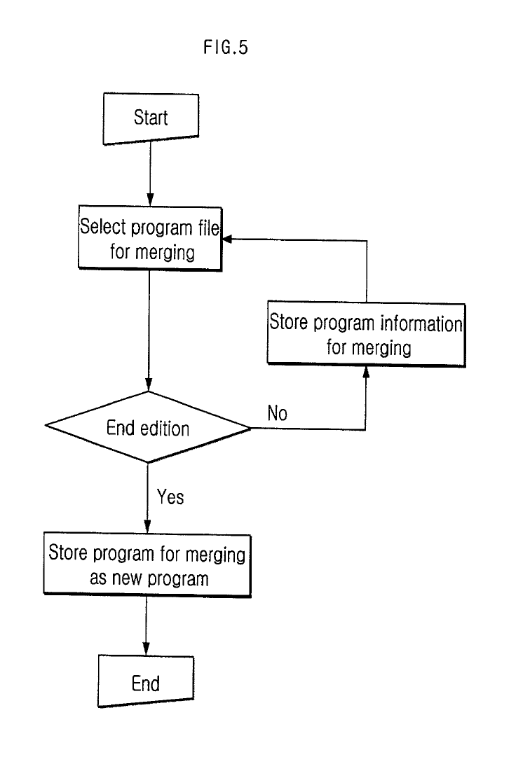

Accordingly, the clipping operation is finished (S80). A process for producing a new program from the recorded programs through a merging operation will now be explained with reference to FIG. 5.

FIG. 5 is a flowchart showing the merging method of the digital broadcasting receiver in accordance with the present invention.

Firstly, the user selects wanted programs Program1, Program2, Program4 for merging from the programs Program1, Program2, . . . , Programn (S100). When the user intends to merge only the selected programs Program1, Program2, Program4, the end of the edition is recognized in S110, and the programs Program1, Program2, Program4 are recorded as a new program (S130). As a result, the new program is produced upon the user's selection. At this time, the programs Program1, Program2, Program4 may be recorded in an order designated by the user.

On the other hand, when the user intends to merge a plurality of files, the end of the edition is not recognized in S110, information of the programs Program1, Program2, Program4 is individually recorded (S120), and a new file is additionally selected. In addition to the programs Program1, Program2, . . . , Programn, the user selects programs Program5_CH2, Program7_CH2 from the programs Program1_CH2, Program2_CH2, Programn_CH2 clipped from a different channel CH2.

When the additional edition for the programs Program5_CH2, Program7_CH2 is finished through S120, S100 and S110, the programs Program1, Program2, Program4 and the additionally-edited programs Program5_CH2, Program7_CH2 are recorded as a new program by employing the information of the programs Program1, Program2, Program4 recorded in S120 (S130).

At this time, a playback order of the programs Program1, Program2, Program4, Program5_CH2, Program7_CH2 may be maintained as it is or adjusted. In addition, a representative program may be recorded in the new program, or individually recorded.

As discussed earlier, the method for editing the program in the digital broadcasting receiver in accordance with the present invention has the following advantages:

Firstly, the PVR system is embodied with various functions due to the editing function of the recorded data of the digital TV.

Secondly, an additional hardware is not required for the editing function of the recorded data, to cut down expenses.

Thirdly, when the time shift function is embodied in an analog TV, the present invention is applied in the same manner.

While the invention has been shown and described with reference to a certain preferred embodiment thereof, it will be understood by those skilled in the art that various changes in form and details may be made therein without departing from the spirit and scope of the invention as defined by the appended claims.

What is claimed is:

1. A method for editing a digital broadcasting material, the method comprising the steps of:
clipping segments from the digital broadcasting material consisting of program segments and being recorded in a recording medium in a stream type;
recording the clipped segments as new programs, respectively; and
selecting some of the recorded programs, and merging the selected programs into a new program,
wherein the step for clipping the segments comprises the steps of:
reproducing the digital broadcasting material; and
selecting a predetermined period of the digital broadcasting material, by designating a start point and an end point thereof.

2. The method of claim 1, wherein the digital broadcasting material is provided in a multiple number.

3. The method of claim 1, wherein the full streams of the digital broadcasting material are reproduced.

4. The method of claim 1, wherein the digital broadcasting material is reproduced at intervals of a predetermined length.

5. The method of claim 1, wherein a representative screen of the digital broadcasting material is reproduced.

6. The method of claim 1, wherein the step for selecting some of the recorded programs, and merging the selected programs into the new program comprises a step for designating an order of the selected programs.

7. The method of claim 1, wherein the step for selecting some of the recorded programs, and merging the selected programs into the new program comprises a step for recording a screen relating to the merged program.

8. A method for editing a program in a personal video recording system, the method comprising the steps of:
reproducing a program recorded by the user;
clipping a predetermined period of the reproduced program, by selecting a start point and an end point; and
recording the respective clipped segments.

9. The method of claim 8, wherein the recorded program is a broadcasting program recorded in a hard disk.

10. The method of claim 8, wherein the recorded and reproduced program is a multi-channel program.

11. The method of claim 8, wherein the full streams of the digital broadcasting material are reproduced.

12. The method of claim 9, wherein the digital broadcasting material is reproduced at intervals of a predetermined length.

13. The method of claim 8, wherein a representative screen of the digital broadcasting material is reproduced.

14. A method for editing a program in a personal video recording system, comprising the steps of:
reproducing a recorded program;
clipping predetermined streams from the reproduced program, by selecting a start point and an end point;
merging the clipped streams; and
recording the merged streams as a new program.

15. The method of claim 14, wherein the step for merging the clipped streams designates an order of the clipped streams, and merges the streams in the designated order.

16. The method of claim 14, wherein the step for merging the clipped streams merges a representative screen of the clipped streams.

17. The method of claim 14, wherein the full streams of the recorded program are reproduced.

18. The method of claim 14, wherein the recorded program is reproduced at intervals of a predetermined length.

19. The method of claim 14, wherein a representative screen of the recorded program is reproduced.

20. The method of claim 14, wherein the reproduced program is a multi-channel program.
